(19) United States
(12) Patent Application Publication
(10) Pub. No.: US 2009/0089487 A1
(43) Pub. Date: Apr. 2, 2009

(54) MULTIPORT SEMICONDUCTOR MEMORY DEVICE HAVING PROTOCOL-DEFINED AREA AND METHOD OF ACCESSING THE SAME

(75) Inventors: Jin-Hyoung KWON, Seongnam-si (KR); Han-Gu SOHN, Suwon-si (KR); Kwang-Myeong JANG, Hwaeseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/197,472

(22) Filed: Aug. 25, 2008

(30) Foreign Application Priority Data
Oct. 1, 2007 (KR) 10-20070098588

(51) Int. Cl. G06F 12/00; G06F 12/02

(52) U.S. Cl. 711/103; 711/149; 711/E12.008; 711/E12.001

(57) ABSTRACT

A multiprocessor system includes a first processor for performing a first task, a second processor for performing a second task, and a multiport semiconductor memory device having a protocol-defined area for defining a specification related to data communication between the first processor and the second processor. The protocol-defined area is located in at least one shared memory area accessible in common by the first processor and the second processor through a first port and a second port, respectively, and is assigned as a predetermined memory capacity to a portion of a memory cell array.

### CROSS REFERENCE TO RELATED APPLICATIONS

A claim of priority is made to Korean Patent Application No. 10-2007-0098588, filed on Oct. 1, 2007, the subject matter of which is hereby incorporated by reference.

### BACKGROUND AND SUMMARY

1. Technical Field

The present invention relates to multiport semiconductor memory devices, and more particularly, to a semiconductor memory device having a shared memory area accessed through multipath, and a multiprocessor system having the same.

2. Description

Universally, remarkable developments are being made in consumer electronic systems. For example, in recent mobile communication systems, such as portable multimedia player (PMP), handheld phone (HHP), or personal digital assistant (PDA), etc., manufacturers are producing products having multiprocessor systems, which incorporate processors in one system to obtain higher speeds and smoother operations.

For example, a portable telephone 1 shown in FIG. 1 may be divided into a body portion 1a and a display portion 1b to meet the converged requirements of users, including telephonic communication, music, games, camera and moving picture functions, and the like. The telephone 1 therefore needs to incorporate a communication processor, configured to perform communication functions (e.g., modulation/demodulation), and an application processor, configured to perform application functions other than the communication functions, in a printed circuit board (PCB) adapted within the body portion 1a.

In such a multiprocessor system, a semiconductor memory which stores processing data may be changed significantly in view of operation or function. For example, multiple access ports are included, which may require simultaneously inputting/outputting data through the access ports.

In general, a semiconductor memory device having multiple access ports is called a multiport memory. More particularly, a memory device having two access ports is called a dual-port memory. A typical dual-port memory may be an image processing video memory having a random access memory (RAM) port accessible in a random sequence and a serial access memory (SAM) port accessible only in a serial sequence.

A multipath accessible semiconductor memory device is distinguishable from a multiport memory. Unlike the configuration of the video memory, a multipath accessible semiconductor memory device includes a dynamic random access memory (DRAM), which has a shared memory area accessible by respective processors through multiple access ports. A memory cell array of the device does not have a SAM port, but is constructed of a DRAM cell.

An example of a conventional memory adequate for a multiprocessor system is disclosed by MATTER et al. (U.S. Patent Application Publication No. 2003/0093628), published May 15, 2003. MATTER et al. generally discloses technology for accessing a shared memory area by multiple processors, in which a memory array includes first, second and third portions. The first portion of the memory array is accessed only by a first processor, the second portion is accessed only by a second processor, and the third portion is a shared memory area accessed by both the first and second processors.

In contrast, a general multiprocessor system, having a nonvolatile memory that stores processor boot codes, e.g., a flash memory, is adapted each to a processor. A DRAM is also adapted as a volatile memory for every corresponding processor. That is, the DRAM and the flash memory are each adapted to one processor. The configuration of the processor system is therefore complicated and costly.

Therefore, a multiprocessor system adaptable to a mobile communication device was developed, as shown in FIG. 2. More particularly, FIG. 2 is a schematic block diagram of a conventional multiprocessor system having a multiport semiconductor memory device (e.g., oneDRAM™, discussed below).

As shown in FIG. 2, in a multiprocessor system including first and second processors 120 and 220, one multiport DRAM 420 and one flash memory 320 are shared. The first processor 120 may function as a communication MODEM processor, for example, performing a determined task, such as modulation and demodulation of communication signals. The second processor 220 may function as an application processor, for example, performing a user convenience function, such as processing communication data, games, amusement, etc. In various configurations, the first processor 120 and the second processor 220 may perform the function of the other processor, or some additional function.

The flash memory 320 may be a NOR flash memory, having a NOR structure for a cell array configuration, or a NAND flash memory, having a NAND structure for a cell array configuration. The NOR flash memory or the NAND flash memory is a nonvolatile memory for which memory cells, e.g., constructed of MOS transistors having floating gates, are formed in an array. Such nonvolatile memory stores data that is not deleted, even when power is turned OFF, such as boot codes of handheld instruments, preservation data, and the like.

In addition, the multipath accessible DRAM 420 functions as a main memory for a data process of the processors 120 and 220. The multipath accessible DRAM 420 shown in FIG. 2 is similar in functionality to a DRAM type memory known as OneDRAM™, provided by Samsung Electronics Co., Ltd. As shown in FIG. 2, both the first and second processors 120 and 220 are able to access the multiport DRAM 420 through two different access paths by way of memory banks and ports, adapted within the multiport DRAM 420, respectively connected to corresponding system buses B1 and B2. The multiple port configuration differs from a general DRAM configuration having a single port.

In the multiport DRAM 420 of FIG. 2, four memory areas 210, 211, 212 and 213 constitute a memory cell array. For example, a first bank 210 may be accessed dedicatedly by the first processor 120 through a first port, and third and fourth banks 212 and 213 may be accessed dedicatedly by the second processor 220 through a second port. The second bank 211 may be accessed by both the first and second processors 120 and 220 through the first and second ports, respectively. As a result, in the memory cell array, the second bank 211 is assigned as a shared memory area, and the first, third and fourth banks 210, 212 and 213 are assigned as dedicated memory areas, each of which is accessible by only one of the corresponding processors.

Mailboxes 252 and 253 are storage areas included in an internal register, separate from the memory cell array within the multiport DRAM 420. The mailboxes 252 and 253 are constructed of latch type storage cells different from the memory cells of the DRAM 420, and thus do not require refresh operations.

For example, when a data interface between the first and second processors 120 and 220 is obtained through the multiport DRAM 420, the first and second processors 120 and 220 can write messages to a counterpart processor of a receiving party using the mailboxes 252 and 253. The counterpart processor of the receiving party reads the written message, recognizes the message of the transmitting processor and performs its corresponding operation.

As described above, when processors perform data communications through a DRAM interface using the mailboxes 252 and 253, a host interface may be eliminated or reduced, resulting in a more compact size of the system structure. They also benefit from an operational advantage of the system. Accordingly, it is valid that the first processor 120, which is not directly connected to the flash memory 320, indirectly accesses the flash memory 320 through the multiport DRAM 420.

As described above, in the multiprocessor system of FIG. 2, which includes the multiport DRAM 420 having a shared memory area, the DRAM 420 and the flash memory 320 are used in common, without having to be assigned to each processor. The number of memories in the system may therefore be reduced, and the system itself may be less complicated and smaller.

As mentioned above, the multipath accessible DRAM 420 shown in FIG. 2 is similar in functionality to a DRAM type memory known as OneDRAM™, provided by Samsung Electronics Co. Ltd. OneDRAM™ is a fusion memory chip that increases data processing speed between a communication processor and a media processor in a mobile device. In general, two processors require two memory buffers. However, the OneDRAM™ solution can route data between processors through a single chip, so two memory buffers are not required. OneDRAM™ reduces data transmission time between processors by employing a dual-port approach. A single OneDRAM™ module can replace at least two mobile memory chips, e.g., within a high-performance smart-phone or other multimedia rich-handset. As data processing speed between processors increases, OneDRAM™ reduces the number of chips, reduces power consumption by about 30 percent and reduces total die area coverage by about 50 percent. As a result, cellular phone speed may increase five times, battery life may be prolonged, and handset design may be slimmer, for example.

Presently, there is no standardized communication protocol for data communications using an interface of the DRAM 420 in the multiprocessor system referred to in FIG. 2. Ideally, processors on both sides of the communication should be able to communicate through a standardized protocol based on mutual operations. However, DRAM operations are different for every processor, thus increasing the time and expense of developing the system or system components.

Therefore, a protocol between processors is needed to regulate memory access to efficiently use a DRAM as a multiport semiconductor memory device. In addition, a memory control algorithm of processors should be standardized for manufacturers to reduce the capacity of messages written to mailboxes and to increase the development of systems. In other words, there is not a standardized communication protocol for data communications through a multiport semiconductor memory device in the conventional art, causing increased time and costs for developing systems and system/development components.

Accordingly, embodiments of the invention provide a multiport semiconductor memory device having a protocol-defined area and a multiprocessor system employing the same, as well as a method of accessing the same. The multiport semiconductor memory device includes an area to efficiently regulate a protocol between processors for accessing a memory.

Embodiments of the invention provide a multiport semiconductor memory device and a multiprocessor system employing the same, which are capable of standardizing a memory control algorithm to reduce the message capacity written to mailboxes and to enhance system development by manufacturers. The multiport semiconductor memory device, according to embodiments of the invention, can assign a protocol-defined area usable as a mailbox within a shared memory area, and can provide a standard protocol necessary for controlling memories by processors.

According to an embodiment of the invention, a multiprocessor system includes a first processor for performing a first task, a second processor for performing a second task, and a multiport semiconductor memory device having a protocol-defined area for defining a protocol related to data communication between the first processor and the second processor. The protocol-defined area is located in at least one shared memory area accessible in common by the first processor and the second processor through a first port and a second port, respectively, and is assigned as a predetermined memory capacity to a portion of a memory cell array.

The multiport semiconductor memory device may further include an internal register accessible in response to an address of the shared memory area to provide a data interface function between the first and second processors. The internal register may be located outside the memory cell array. The internal register may include a semaphore area for storing a control authority for the shared memory area, and multiple mailbox areas for storing a message for one of the first and second processors corresponding to a data transmission direction.

The protocol-defined area may be configured to store a portion of the message, which had to be stored in at least one of the plurality of mailbox areas, in DRAM memory cells, in substitution for the at least one mailbox area. The message may be stored in at least one of the plurality of mailbox areas. Also, the protocol-defined area may store a command set, and/or the protocol-defined area may store a command, address or flag data for a data communication protocol between the first and second processors.

The system may further include a NAND type flash memory accessible by the second processor, the NAND type flash memory having a NAND type memory cell structure.

The multiport semiconductor memory device may further include at least one dedicated memory area accessible by one of the first processor or the second processor within the memory cell array.

The first task of the first processor may be a modulation/demodulation function. The second task of the second processor may be a multimedia information processing function.

The multiprocessor system may be one of vehicle-use mobile phone, a portable phone, a portable multimedia player (PMP), a PlayStation Portable® (PSP®), or a personal digital assistant (PDA), for example. The predetermined memory capacity may be a unit of a memory bank.

According to another embodiment of the invention, a multiport semiconductor memory device operationally connected between a first processor performing a first task and a second processor performing a second task includes at least one shared memory area and an internal register. The at least one shared memory area is respectively accessible through different ports by the first processor and the second processor and assigned as a predetermined memory capacity to a portion of a memory cell array. The at least one shared memory area includes a disable area disabled in response to a specific address and a protocol-defined area for defining a specification related to a data communication between the first processor and the second processor. The internal register is accessible in response to the specific address of the shared memory area to provide a data interface between the first processor and the second processor. The internal register is located outside the memory cell array.

The first processor may be a communication processor and the second processor may be an application processor. The internal register may include a semaphore area for storing a control authority for the shared memory area and multiple mailbox areas for storing a message to be applied to one of the first processor and the second processor corresponding to a data transmission direction.

The protocol-defined area may store a portion of a message, which had to be stored in at least one of the plurality of mailbox areas, in DRAM memory cells, in substitution for the at least one mailbox area. The protocol-defined area may store a command, address or flag data for a data communication protocol between the first and second processors.

The device may further include at least one dedicated memory area accessible by one of the first processor or the second processor within the memory cell array.

According to another embodiment of the invention, a method is provided for driving a multiport semiconductor memory device in a multiprocessor system, the multiprocessor system including the multiport semiconductor memory device operationally connected between a first processor performing a first task and a second processor performing a second task, and a nonvolatile semiconductor memory device operationally connected to the second processor. The method includes arranging a protocol-defined area and a disable area within a memory cell array, the protocol-defined area defining a specification related to a data communication between the first and second processors and being accessible in common through different ports within the multiport semiconductor memory device, and the disable area being disabled in response to a specific address; preparing an internal register outside the memory cell array to be accessible in response to the specific address; and regularly writing a message to a pre-defined area by one of the first and second processors occupying the protocol-defined area, and then performing the data communication.

According to another embodiment of the invention, a method is provided for accessing a multiport semiconductor memory device in a multiprocessor system, the multiprocessor system including the multiport semiconductor memory device operationally connected between a first processor performing a first task and a second processor performing a second task, and a nonvolatile semiconductor memory device operationally connected to the second processor. The method includes preparing at least one shared memory area accessible in common by the first and second processors through different ports within the multiport semiconductor memory device and assigned as a predetermined memory capacity to a portion of a memory cell array. The shared memory area includes a disable area disabled in response to a specific address and a protocol-defined area for defining a specification related to a data communication between the first and second processors. The method further includes arranging an internal register outside the memory cell array accessible in response to a specific address of the shared memory area; writing a message to a pre-defined area by one of the first and second processors accessing the protocol-defined area and writing data to a data storage area of the shared memory area, and then indicating a write event to a mailbox of the internal register; and reading the mailbox by the other one of the first and second processors to retrieve the message written to the protocol-defined area, and then reading data written to the data storage area of the shared memory area.

As described above, according to embodiments of the invention, a protocol-defined area usable as a mailbox within a shared memory area is assigned, and a standard protocol necessary for controlling memories by processors is provided, thereby standardizing a memory control algorithm for system manufacturing.

### BRIEF DESCRIPTION OF THE DRAWINGS

The embodiments of the present invention will be described with reference to the attached drawings, which are given by way of illustration only and thus are not limiting of the present invention, wherein:

FIG. 1 is a plan view illustrating a portable phone;

FIG. 2 is a block diagram illustrating a conventional multiprocessor system;

FIG. 3 is a block diagram of a multiprocessor system employing a multiport semiconductor memory device having a protocol-defined area, according to an exemplary embodiment of the invention;

FIG. 4 is a diagram illustrating an example of the protocol-defined area of FIG. 3, according to an exemplary embodiment of the invention;

FIG. 5 is a timing diagram illustrating operations related to data transmission of FIG. 3, according to an exemplary embodiment of the invention;

FIG. 6 is a block diagram illustrating operating characteristics of the multiport semiconductor memory device of FIG. 3, according to an exemplary embodiment of the invention;

FIG. 7A is a circuit diagram and FIG. 7B is a timing diagram illustrating a control unit of FIG. 6 and associated operation timing, according to an exemplary embodiment of the invention;

FIG. 8 is a diagram illustrating configuration and access correlation of an internal register and memory banks of FIG. 6, according to an exemplary embodiment of the invention;

FIG. 9 is a block diagram illustrating multipath access to a shared memory area of FIG. 6, according to an exemplary embodiment of the invention; and

FIG. 10 is a circuit diagram illustrating an address multiplexer of FIG. 9, according to an exemplary embodiment of the invention.

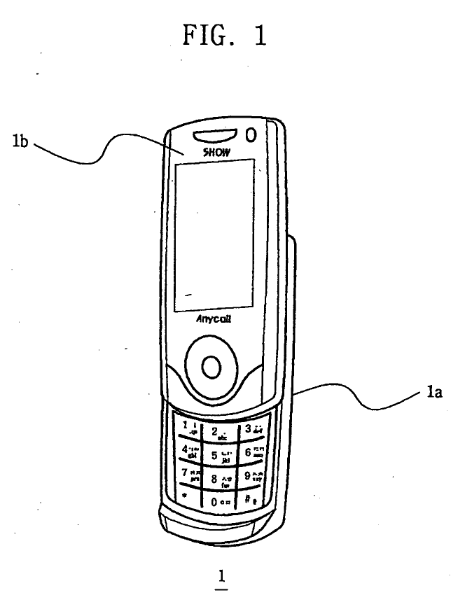

### DETAILED DESCRIPTION

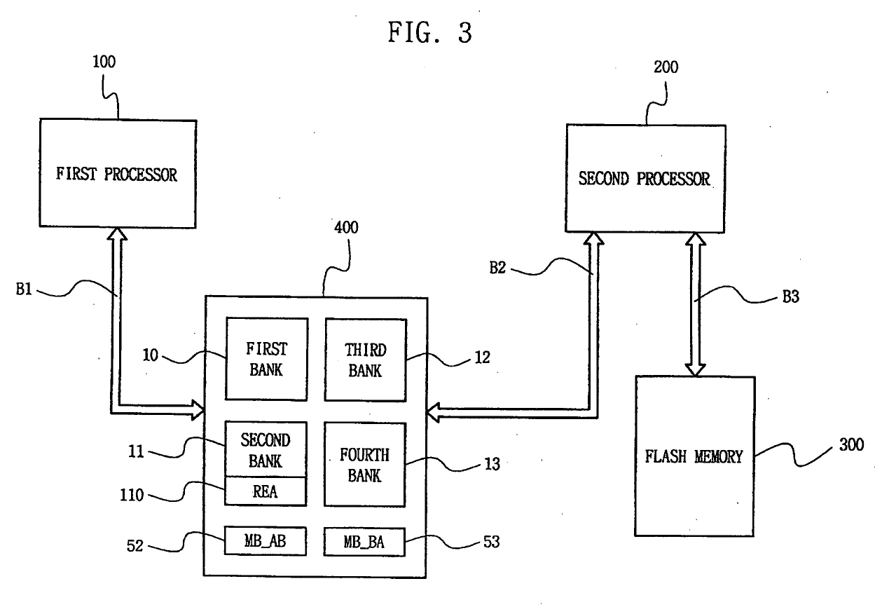

The present invention will now be described more fully with reference to FIGS. 3 to 10, in which exemplary embodiments of the invention are shown. The invention may, however, be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. Throughout the drawings and written description, like reference numerals will be used to refer to like or similar.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For purposes of clarity, a detailed description of other examples, publication methods, procedures, general dynamic random access memories and circuits as known functions and systems are not specifically described.

Representative embodiments of the invention include a multiport semiconductor memory device having a protocol-defined area and a multiprocessor system employing the same, and a method of accessing the same, as described below, referring to the accompanied drawings.

Generally, according to various embodiments, a portion of shared memory area accessible in common by processors is predetermined to be a protocol-defined area. Information for the communication between processors, e.g., commands, addresses, etc., is stored in the predetermined area. Therefore, the protocol-defined area may be utilized as an internal register, and data communications between processors through a multiport semiconductor memory device may be performed according to a predetermined standard or protocol. Accordingly, a standardized oneDRAM™ control algorithm, for example, may be provided to the processors and a mailbox size of the OneDRAM™ may be reduced. Additionally, a standardized protocol among processor manufacturers is provided, making system development easier.

FIG. 3 is a block diagram of a multiprocessor system employing a multiport semiconductor memory device with a protocol-defined area, according to an illustrative embodiment of the invention.

Referring to FIG. 3, the depicted multiprocessor system may be included in a portable phone, a vehicle-use mobile phone, a PDA, a portable multimedia player (PMP), a PSP® (PlayStation® Portable), or the like. According to the depicted structure of the system, one multiport DRAM 400 and one flash memory 300 in the multiprocessor system are shared by first processor 100 and second processor 200.

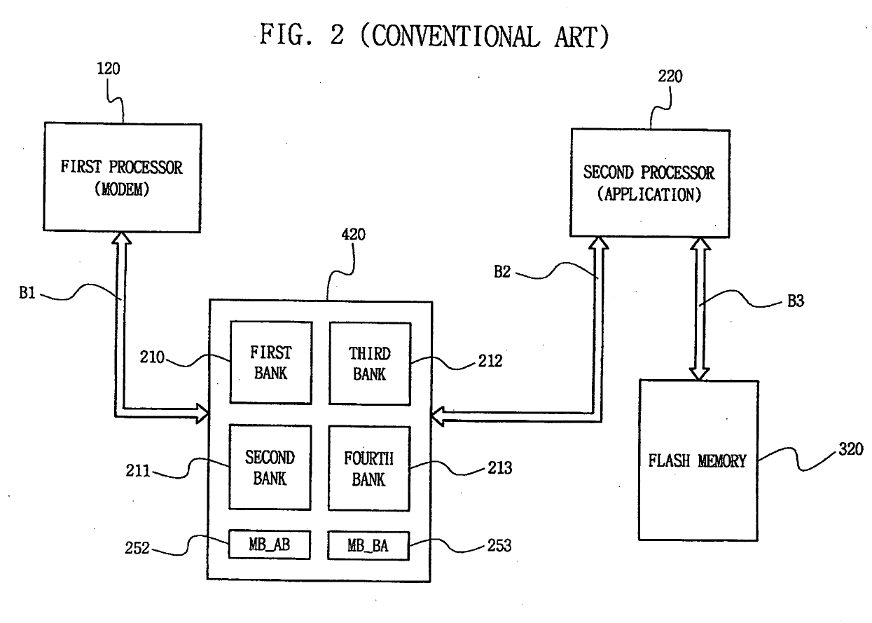

In the multiprocessor system of FIG. 3, unlike the structure illustrated in FIG. 2, a protocol-defined register area (REA) 110 is defined in a second bank 11 as a shared memory area. That is, within at least one shared memory area 11, accessible in common through different ports by the first and second processors 100 and 200 and assigned by a unit of predetermined memory capacity to a portion of memory cell array, a protocol-defined area 110 is provided for defining a specification related to data communications between processors.

More particularly, in the multiport DRAM 400 of FIG. 3, four memory areas 10, 11, 12 and 13 may constitute a memory cell array. In this case, for example, a first bank 10 may be accessed dedicatedly by the first processor 100 through a first port, and third and fourth banks 12 and 13 may be accessed dedicatedly by the second processor 200 through a second port. The second bank 11 may be accessed by both the first and second processors 100 and 200 through the first and second ports, respectively. As a result, in the memory cell array, the second bank 11 is assigned as a shared memory area, and the first, third and fourth banks 10, 12 and 13 are assigned as dedicated memory areas that are respectively accessible by one processor.

In an embodiment, the four memory areas 10, 11, 12 and 13 may be individually configured as DRAM unit banks. Each bank may have a memory storage capacity of 64 Mb, 128 Mb, 256 Mb, 512 Mb or 1024 Mb, for example.

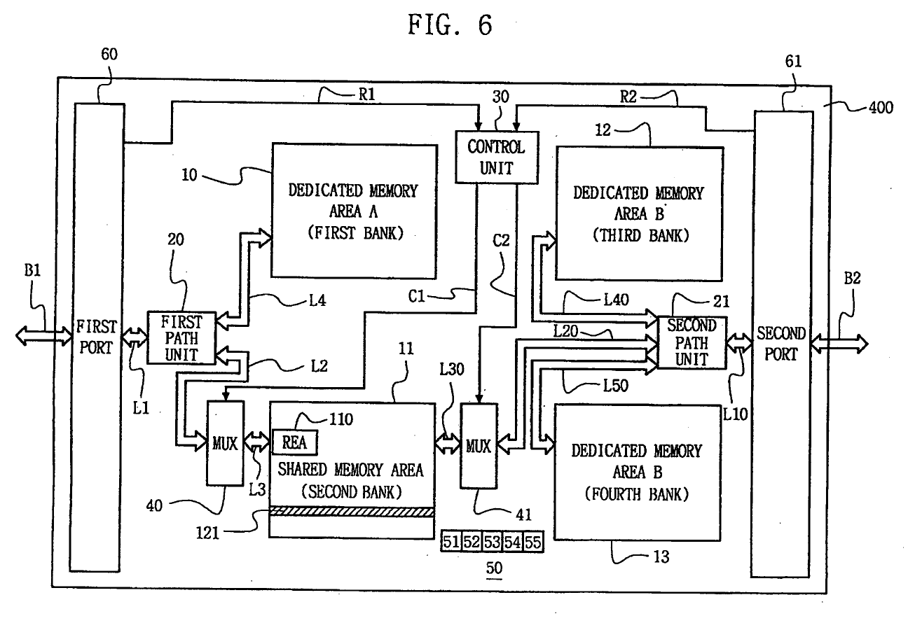

In FIG. 3, mailboxes 52 and 53 are storage areas included in an internal register (e.g., internal register 50 shown in FIG. 6) configured separately from the memory cell array within the multiport DRAM 400. The mailboxes 52 and 53 may be latch type storage cells, for example, different from the memory cells of the DRAM 400, and thus do not require refresh operations.

For example, when a data interface between the first and second processors 100 and 200 is obtained through the multiport DRAM 400, the first and second processors 100 and 200 can write a message matching a format through the protocol-defined area 110, and can transmit a message write result to the counterpart processor through the mailboxes 52 and 53.

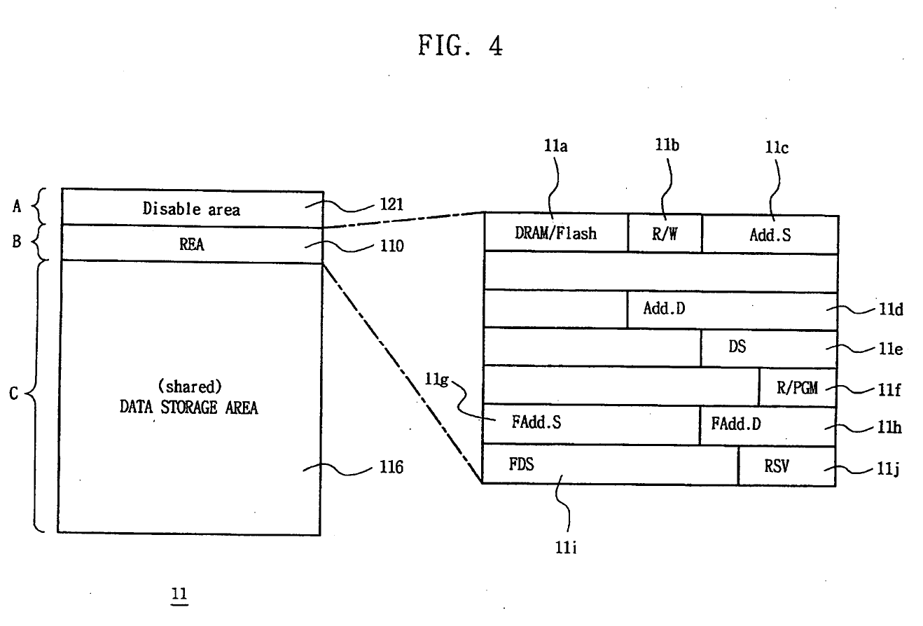

FIG. 4 illustrates an example of a protocol-defined area defined in the shared memory area of FIG. 3, according to an illustrative embodiment of the invention.

With reference to FIG. 4, the second bank 11 of FIG. 3 is divided into three areas. Area A is a disable area 121 which does not store data, and area C is a data storage area 116 which stores data. The disable area A may be a row disable area that is disabled to enable a register area having a semaphore/mailbox/check bit.

According to an embodiment of the invention, area B is the protocol-defined area 110 within the second bank 11, which may be defined as an area of about 2 Kbytes, similar to the disable area 121. Data for commands, addresses, messages, etc., are written in cells comprised of DRAM cells.

Within the protocol-defined area 110, a DRAM/Flash area 11a may be assigned two bits, for example, and contains data indicating a command of DRAM or flash memory. For example, data “11” stored in the DRAM/Flash area 11a indicates a command to access the DRAM, and data “00” stored the DRAM/Flash area 11a indicates a command to access the flash memory. A Read/Write (R/W) area 11b may be assigned one bit, for example, and contains data indicating read/write operations of the shared memory area. For example, data “1” stored in the R/W area 11b indicates a command to read data from the shared memory area, and data “0” stored in the R/W area 11b indicates a command to write data to the shared memory area.

Start address (Add.S) area 11c indicates a start address of the shared memory area, and may be assigned 26 bits, for example. Destination address area (Add.D) 11d indicates a destination address of the shared memory area, and may be assigned 26 bits, for example. Data size (DS) area 11e indicates size of the data to be transmitted, and may be assigned 10 bits, for example. Read/program (R/PGM) area 11f indicates read/program operations of the flash memory, and may be assigned one bit, for example. Flash start address (FAdd.S) area 11g indicates a start address to read/program data from/to the flash memory, and may be assigned 30 bits, for example. Flash destination address (FAdd.D) area 11h indicates a destination address to read/program data from/to the flash memory, and may be assigned 30 bits, for example. Flash data size (FDS) area 11i indicates a size of data to be read/programmed from/to flash memory, and may be assigned 10 bits, for example. Reserve (RSV) area 11j is a spare area, which may be additionally defined, if necessary.

When a standardized protocol is provided, as described above with reference to FIG. 4, processor manufacturers do not need to individually define respective protocols, making it easier to provide a unified interprocessor communication (IPC) driver. In other words, an IPC algorithm need not be established on a manufacturer-by-manufacturer basis, e.g., through technological cooperation between enterprises. Therefore, expenditure of resources may be reduced in developing IPC drivers for memory link architectures.

Further, the storage capacity of mailboxes assigned within an internal register may be substantially reduced by establishing arrangement of the protocol-defined area 110. Most contents of messages to be transferred are stored in the protocol-defined area 110. Therefore, each of the mailboxes is used to store information on whether a message exists. The mailboxes assigned 32 bits thus can be reduced up to 2 bits.

In addition, boundaries may be regulated for access operations of a OneDRAM™, for example. Therefore, it is available to define test items to ensure test coverage.

Consequently, a protocol-defined area, which may be used as a mailbox in the shared memory area, has a standardized protocol necessary for controlling memories by processors. Accordingly, processor manufacturers benefit from a standardized memory control algorithm, and system development is simplified.

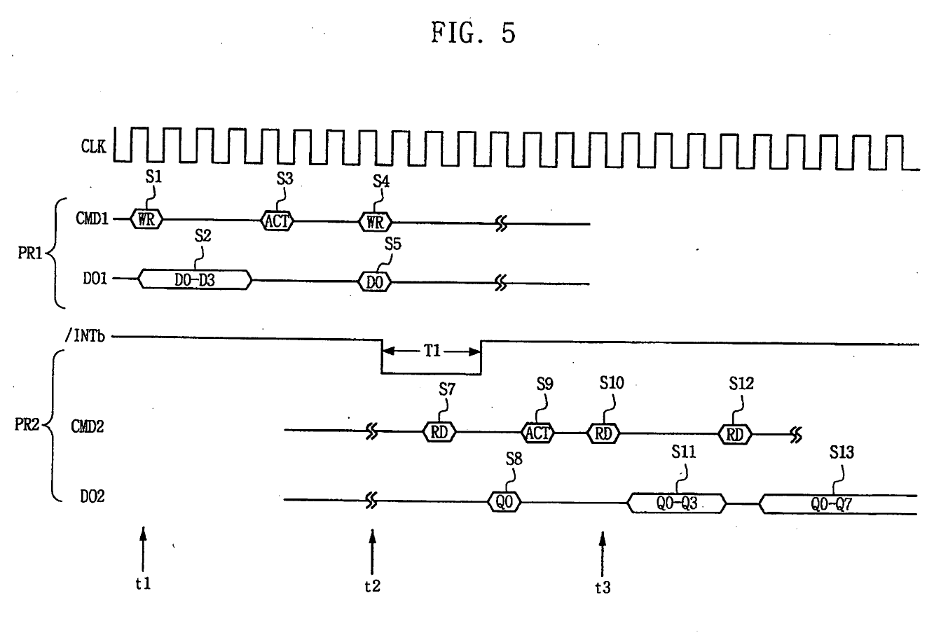

FIG. 5 is a timing diagram showing sample timings for a data transmission operation of the multiprocessor system of FIG. 3, according to an illustrative embodiment of the present invention. In FIG. 5, CLK indicates a system clock, PR1 indicates timing operations of the first processor 100, and PR2 indicates timing operations of the second processor 200. CMD1 shows commands from the first processor 100. DO1 designates data written to the protocol-defined area 110 in response to commands from the first processor 100. /INTb indicates an interrupt signal, which is transmitted from the DRAM 400 to the second processor 200. CMD2 represents commands from the second processor 200, and DO2 designates data read from the data storage area 116 (FIG. 4) and data read from the protocol-defined area 110 in response to commands from the second processor 200. The timings shown in FIG. 5 are described in detail below.

FIG. 6 is a block diagram illustrating operating characteristics of a multiport semiconductor memory device of FIG. 3, according to an illustrative embodiment of the present invention.

In FIG. 6, dedicated memory area A (first bank 10) is accessible by the first processor 100 of FIG. 3 through first port 60, and dedicated memory areas B (third bank 12 and fourth bank 13) are accessible by the second processor 200 of FIG. 3 through second port 61. Also, the shared memory area (second bank 11) is accessible by both the first and second processors 100 and 200 through the first and second ports 60 and 61, respectively.

In FIG. 6, internal register 50, functioning as an interface unit to interface between processors, is accessible by both the first and second processors 100 and 200. The internal register 50 may be constructed from flip-flops, data latches or static random access memory (SRAM) cells, for example. The internal register 50 may include semaphore area 51, first mailbox area 52 (e.g., mailbox A to B), second mailbox area 53 (e.g., mailbox B to A), check bit area 54, and reserve area 55. The areas 51-55 may be enabled in common by a specific row address, and accessed individually by an applied column address. For example, when row address (0x7FFFFFFFh˜0x8FFFFFFFh) is applied, indicating a specific row area 121 of the shared memory area (second bank 11), a portion (disable area 121) of the shared memory area is disabled, and the internal register 50 is enabled.

Control authority for the shared memory area (second bank 11), is written in the semaphore area 51, which is a familiar term to processing system developers. In the first and second mailbox areas 52 and 53, a message may be written according to a predetermined transmission direction. The message may include, for example, authority requests, commands, transmission data indicating an address of a shared memory in which an address, data size or data is stored, and/or commands, etc., given to counterpart processors. The first and second mailbox areas 52 and 53 are the same as the mailboxes 52 and 53 of FIG. 3, and therefore have the same reference numbers in the drawings.

As shown, the disable area 121 and the protocol-defined area 110, defining a specification related to a data communication between processors to realize the invention, are assigned to the shared memory area (second bank 11).

A control unit 30 controls a path to operationally connect the second bank 11 to the first processor 100 or the second processor 200. A signal line R1, connected between the first port 60 and the control unit 30, transfers a first external signal applied through bus B1 from the first processor 100. A signal line R2, connected between the second port 61 and the control unit 30, transfers a second external signal applied through bus B2 from the second processor 200. The first and second external signals may include a row address strobe signal RASB, a write enable signal WEB and a bank selection address BA individually applied through the first and second ports 60 and 61. Signal lines C1 and C2, respectively connected between the control unit 30 and multiplexers 40 and 41, transfer path decision signals MA and MB to operationally connect the second bank 11 to the first or second port 60 or 61.

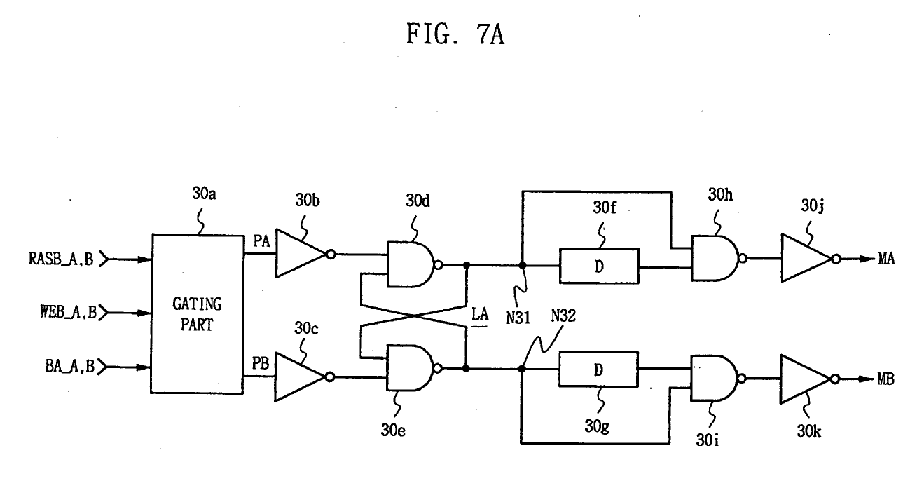

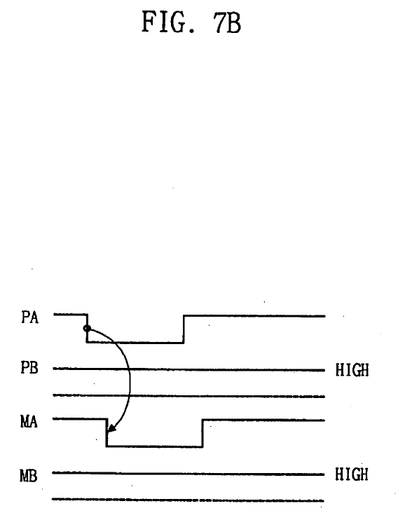

FIGS. 7A and 7B are diagrams illustrating the control unit shown in FIG. 6 and associated operation timings, according to an illustrative embodiment of the present invention.

Referring to FIG. 7A, the control unit 30 has a gating part 30a, which includes multiple logic gates. The gating part 30a receives bank selection addresses BA_A, BA_B, write enable signals WEB_A, WEB_B and row address strobe signals RASB_A, RASB_B, which are respectively applied through the first and second ports 60 and 61. The gating part 30a generates gating signals PA and PB, the timings of which are shown in FIG. 7B. For example, when the gating signal PA is output with a logic low level, a path decision signal MA is output as a logic low level. Meanwhile, when the gating signal PA is output with a logic low level, the gating signal PB is maintained as a logic high level, and a path decision signal MB is output as a logic high level.

When a row address strobe signal RASB_A, RASB_B is first input through one of the ports, the gating part 30a assigns the shared memory area (second bank 11) to that port. For example, when the row address strobe signals RASB_A, RASB_B are applied simultaneously, the processor having priority through a system specification may access the shared memory area (second bank 11).

The control unit 30 also include inverters 30b, 30c, 30j and 30k, a latch LA constructed of NAND gates 30d and 30e, delay devices 30f and 30g, and NAND gates 30h and 30i, with a wiring structure shown in FIG. 7A. In this configuration, the path decision signal MA results from the gating signal PA being delayed by a given time and latched, and the path decision signal MB results from the gating signal PB being delayed by a given time and latched.

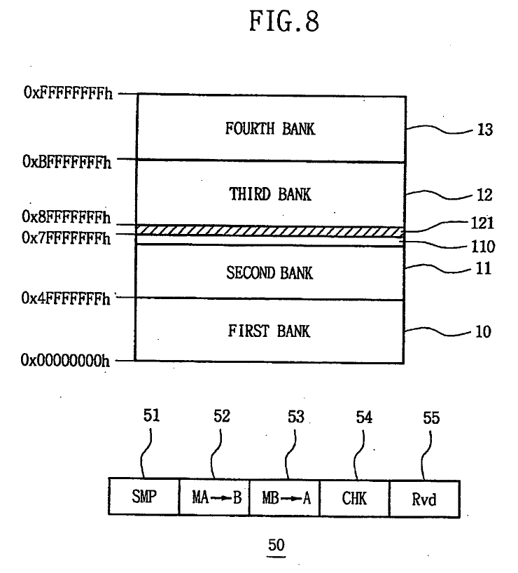

FIG. 8 is a diagram illustrating a configuration and access correlation of an internal register and memory banks shown in FIG. 6, according to an illustrative embodiment of the present invention.

Referring to FIG. 8, it is assumed that that memory banks 10-13 each have a capacity of 16 mega bits. The second bank 11, as the shared memory area, includes the disable area 121 and the protocol-defined area 110. A specific row address (0x7FFFFFFFh˜0x8FFFFFFFh, where one row size=2 KB) enabling one optional row of the second bank 11 within the DRAM 400 is temporarily assigned to the internal register 50 as the interface unit. Then, when the specific row address (0x7FFFFFFFh˜0x8FFFFFFFh) is applied, a corresponding specific word line 121 of the first bank 11 is disabled, but the internal register 50 is enabled. As a result, from a system aspect, the semaphore area 51 and mailbox areas 52 and 53 may be accessed using a direct address mapping method, and from a DRAM internal aspect, a command directed to a corresponding disabled address is decoded, thus performing a mapping to a DRAM internal register. Thus, a memory controller of the chip set produces a command for this area through the same method as other memory cells. Referring to FIG. 6, the semaphore area 51, the first mailbox area 52 and the second mailbox area 53 may each be assigned 16 bits, and the check bit area 54 may be assigned 4 bits, for example.

The protocol-defined area 110 includes regulated portions, which are predetermined to effectively provide a communication standard, as described above with reference to FIG. 4. Since the protocol-defined area 110 is a portion of the shared memory area composed of DRAM cells, the protocol-defined area 110 requires a refresh operation.

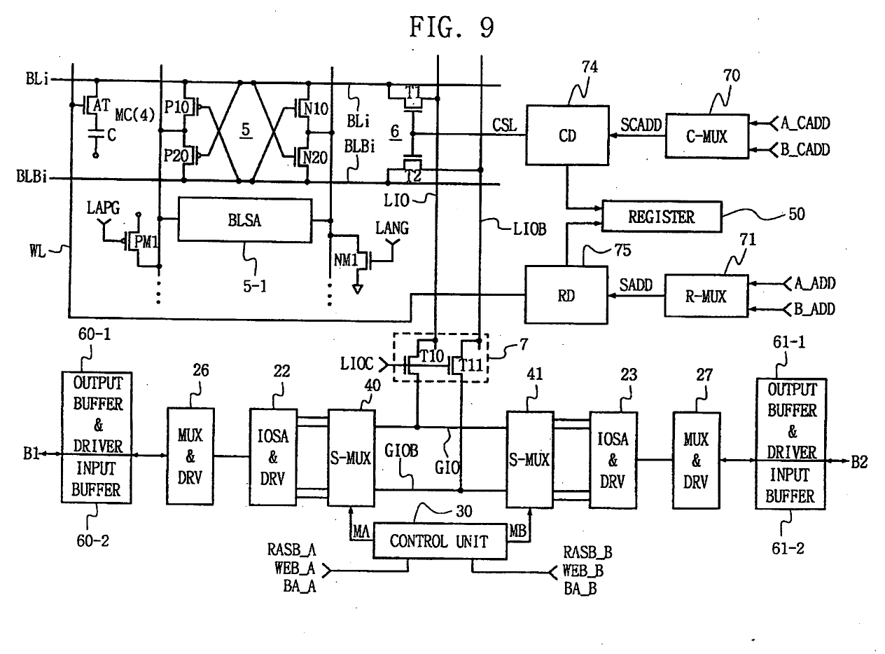

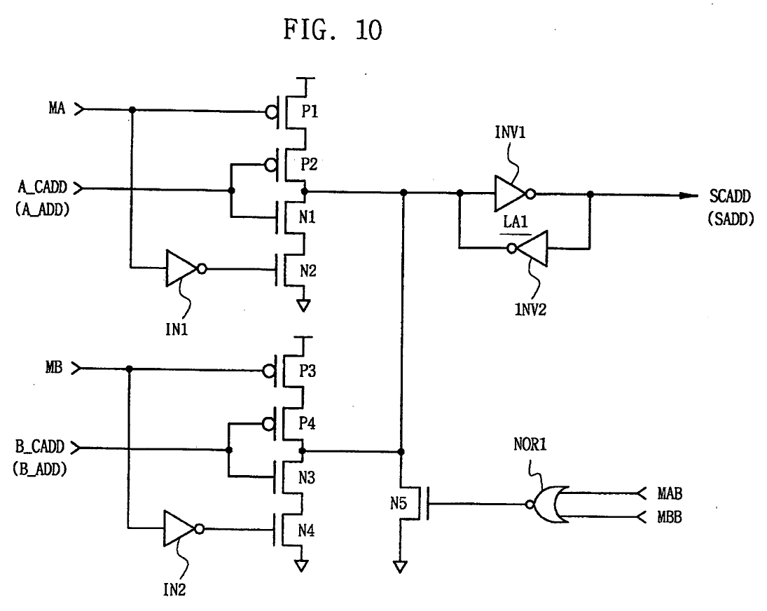

FIG. 9 is a block diagram illustrating multipath access to a shared memory area, as shown in FIG. 6, according to an illustrative embodiment of the present invention. FIG. 10 is a circuit diagram illustrating an address multiplexer shown in FIG. 9, according to an illustrative embodiment of the present invention.

FIG. 10, in particular, illustrates an example of one of a row address multiplexer 71 or a column address multiplexer 70, shown in FIG. 9. In an embodiment, one address multiplexer may be realized using the same circuit, and may function as a row address multiplexer or a column address multiplexer, according to a type of input signal.

Referring to FIG. 10, assuming for purposes of explanation that it depicts column address multiplexer 70, the column address multiplexer 70 includes clocked-CMOS inverters constructed of PMOS and NMOS transistors P1-P4 and N1-N4, respectively, and an inverter latch LA1 constructed of inverters INV1 and INV2. The column address multiplexer 70 receives two column addresses A_CADD and B_CADD, respectively provided through two ports (including two input terminals), and selects one of the two inputs according to a logic state of path decision signal MA, MB. The selected column address is output as a selection column address SCADD. An NMOS transistor N5 and a NOR gate NOR1 are adapted to provide a discharge path between an input terminal of the inverter latch LA1 and a ground. Inverters IN1 and IN2 invert a logic state of the path decision signal MA, MB.

In FIG. 10, for example, when the path decision signal MA is applied with a logic low level, the column address A_CADD applied through first port 60 is inverted through an inverter constructed of PMOS and NMOS transistors P2 and N1, and is again inverted through the inverter INV1 and output as the selection column address SCADD. Meanwhile, the path decision signal MB is applied with a logic high level, thus the column address B_CADD, which can be applied through the second port 61, is not provided to an input terminal of the latch LA1 since the inverter constructed of PMOS and NMOS transistors P4 and N3 is in an inactive state. As a result, the column address B_CADD is not output as the selection column address SCADD. When an output of the NOR gate NOR1 becomes a high level, the NMOS transistor N5 is turned on and a logic level latched to the latch LA1 is initiated as a low level.

Multipath data access during normal operation of the first processor 100 will now be described with reference to FIG. 9.

In FIG. 9, memory cell (MC) 4 indicates a memory cell belonging to the shared memory area (second bank 11) of FIG. 6. A second multiplexer 40 for a port A and a second multiplexer 41 for a port B, as well as an input/output sense amplifier and driver 22 for the port A and an input/output sense amplifier and driver 23 for the port B, are disposed symmetrically on the second bank 11. Within the second bank 11, the memory cell 4, which includes an access transistor AT and a storage capacitor C, forms a unit memory device. The memory cell 4 is connected with intersections of multiple word lines and multiple bit lines, thus constituting a matrix type bank array.

A word line WL, as shown in FIG. 9, is located between a gate of the access transistor AT of the memory cell 4 and a row decoder 75. The row decoder 75 applies a row decoded signal to the word line WL or the register 50 in response to a selection row address SADD of row address multiplexer 71. A bit line BLi, constituting a bit line pair, is coupled to a drain of the access transistor AT and a column selection transistor T1. A complementary bit line BLBi is coupled to a column selection transistor T2. PMOS transistors P10 and P20 and NMOS transistors N10 and N20 coupled to the bit line pair BLi, BLBi constitute a bit line sense amplifier 5. Sense amplifier driving transistors PM1 and NM1 each receive a drive signal LAPG, LANG, and drive the bit line sense amplifier 5.

A column selection gate 6, including column selection transistors T1 and T2, is coupled to a column selection line CSL transferring a decoded column signal of column decoder 74. The column decoder 74 applies a decoded column signal to the column selection line CSL and the register 50 in response to a selection column address SCADD of column address multiplexer 70.

In FIG. 9, a local input/output line pair LIO, LIOB is coupled to a first multiplexer (F-MUX) 7. When transistors T10 and T11 of the first multiplexer 7 are turned ON in response to a local input/output line control signal LIOC, the local input/output line pair LIO, LIOB is coupled to a global input/output line pair GIO, GIOB. Then, data of the local input/output line pair LIO, LIOB is transferred to the global input/output line pair GIO, GIOB in a data read operating mode. On the other hand, write data applied to the global input/output line pair GIO, GIOB is transferred to the local input/output line pair LIO, LIOB in a data write operating mode. The local input/output line control signal LIOC may be a signal generated in response to a decoded signal output from the row decoder 75.

When the path decision signal MA output from control unit 30 is in an active state, read data transferred to the global input/output line pair GIO, GIOB is transferred to the input/output sense amplifier and driver 22 through the second multiplexer 40. The input/output sense amplifier and driver 22 amplifies data having a level weakened in the course of the transfer procedure through several data paths. The read data output from the input/output sense amplifier and driver 22 is transferred to the first port 60 through multiplexer and driver 26. Meanwhile, the path decision signal MB is in an inactive state, thus the second multiplexer 41 is disabled. Accordingly, an access operation of the second processor 200 to the shared memory area (second bank 11) is intercepted. However, the second processor 200 can still access the dedicated memory areas B (third and fourth banks 12 and 13) through the second port 61.

When the path decision signal MA output from the control unit 30 is in an active state, write data applied through first port 60 is transferred to the global input/output line pair GIO, GIOB, sequentially passing through the multiplexer and driver 26, the input/output sense amplifier and driver 22 and the second multiplexer 40. When the first multiplexer (F-MUX) 7 is activated, the write data is transferred to the local input/output line pair LIO, LIOB and then stored in a selected memory cell 4.

Output buffer and driver 60-1 and input buffer 60-2, as shown in FIG. 9, may correspond to or be included in the first port 60 of FIG. 6, and output buffer and driver 61-1 and input buffer 61-2 may correspond to or be included in the second port 61 of FIG. 6. The second multiplexers 40 and 41 have mutually complementary operations to prevent the two processors from simultaneously accessing data of the second bank 11.

The first and second processors 100 and 200 commonly use circuit devices and lines that are adapted between global input/output line pair GIO, GIOB and memory cell 4 in an access operation. The first and second processors 100 and 200 independently use input/output related circuit devices and lines adapted between respective ports 60, 61 and the second multiplexers 40, 41. Further, the first and second processors 100 and 200 share, through the first and second ports 60 and 61, respectively, the global input/output line pair GIO, GIOB of the second bank 11, the local input/output line pair LIO, LIOB operationally connected to the global input/output line pair GIO, GIOB, the bit line pair BL, BLB operationally connected to the local input/output line pair LIO, LIOB through the column selection signal CSL, the bit line sense amplifier 5 on the bit line pair BL, BLB to sense and amplify data of bit line, and the memory cell 4, the access transistor AT of which is connected to the bit line BL.

As described above, in the semiconductor memory device of the exemplary embodiment shown in FIG. 9, processors can access in common shared memory area(s), thereby attaining an interface function between processors 100 and 200. The processors 100 and 200 perform a data communication through the commonly accessible shared memory area (second bank 11) using the internal register 50 functioning as an interface unit. Also, a precharge skip problem can be solved in an access authority transfer.

Operation of a multiport semiconductor memory device, including a protocol-defined area defining a specification related to data communications between processors, is described with reference to FIG. 5.

Referring again to FIG. 5, when the first processor 100 applies a write command S1 to the first port 60 (FIG. 6) at a time point t1 and applies write data (data format based on the regulation of FIG. 4) to be written to the protocol-defined area 110, for example, the write data is written to memory cells adapted within the protocol-defined area 110 through the write path described with reference to FIG. 9. The written-data corresponds to data S2 of FIG. 5. Then, when an active command S3 and a write command S4 are sequentially applied to the first port 60, data S5 representing that the write data has been recorded is stored in the first mailbox 52 as shown in FIG. 8. In this case, flag data of the semaphore 51 is changed to indicate the control authority has been transferred to the second processor 200. Thus, at a time point t2, the mailbox 52 and the semaphore 51 are simultaneously checked, and the DRAM 400 transfers interrupt signal /INTb to the second processor 200 in response to the writing operation of mailbox 52.

Accordingly, the second processor 200 applies a read command S7 to the second port 61 (FIG. 6) to read the data written to the mailbox 52. The data stored in the mailbox 52 is read as read data S8 in response to the read command S7, and is output to the second processor 200 through bus B2 (FIG. 6). As a result, it is clarified that the second processor 200 has received the message of the first processor 100 through the protocol-defined area 110 by reading the read data S8.

Then, when a read command S10 is given after an active command S9 of the second processor 200, the data S2 previously written to memory cells of the protocol-defined area 110 is read as read data S11 after time point t3. Thus, by analyzing the read data S11, the second processor 200 recognizes how much data has been written by the first processor 100, and at which addresses of the shared memory area. The second processor 200 then applies read command S12 to the second port 61 (FIG. 6) depending on the analysis.

Accordingly, transfer data of the first processor 100, written to the data storage area 116 of FIG. 4, are read as read data S13 by the second processor 200 through the data read path described above, with reference to FIG. 9. Similarly, the first processor 100 can indirectly access data stored in the flash memory through the DRAM interface with assistance of the second processor 200.

As described above, a protocol-defined area usable as a mailbox is assigned within shared memory. Also, a standard protocol is provided for processors to control memories, thereby standardizing a memory control algorithm for processor manufacturers, which simplifies development of systems.

It is understood that the multiprocessor system according to embodiments of the present invention is not limited to two processors, the number of which may be increased to three or more. Further, in the multiprocessor system, each processor may be a microprocessor, CPU, digital signal processor, micro controller, reduced-command set computer, complex command set computer, or the like. The scope of the invention is therefore not limited to the number of processors in the system. Further, the scope of the invention is not limited to any special combination of processors.

It will be apparent to those skilled in the art that modifications and variations can be made in the present invention without deviating from the spirit or scope of the invention. Thus, it is intended that the present invention cover any such modifications and variations. For example, the configuration for a shared memory bank of a multiport semiconductor memory or the configuration of circuit and access method may be diversely changed.

In addition, an internal determination format of a protocol-defined area may be changed or the number of determination format areas may increase or decrease. Further, although the nonvolatile memory is depicted as flash memory and the volatile memory is depicted as a multiport DRAM in the examples provided above, other volatile and nonvolatile memories, such as phase-change random access memory (PRAM) or a static random access memory (SRAM), may be incorporated. Accordingly, these and other modifications are within the spirit and scope of the invention.

In the drawings and specification, there have been disclosed exemplary embodiments of the invention and, although specific terms are employed, they are used in a generic and descriptive sense and not for purposes of limitation. While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A multiprocessor system comprising:
a first processor for performing a first task;
a second processor for performing a second task; and
a multiport semiconductor memory device comprising a protocol-defined area, for defining a protocol related to data communication between the first processor and the second processor, the protocol-defined area being located in at least one shared memory area accessible in common by the first processor and the second processor through a first port and a second port, respectively, and assigned as a predetermined memory capacity to a portion of a memory cell array.

2. The system of claim 1, wherein the multiport semiconductor memory device further comprises an internal register accessible in response to an address of the shared memory area to provide a data interface function between the first and second processors, the internal register being located outside the memory cell array.

3. The system of claim 2, wherein the internal register comprises a semaphore area for storing a control authority for the shared memory area, and a plurality of mailbox areas for storing a message for one of the first and second processors corresponding to a data transmission direction.

4. The system of claim 3, wherein the protocol-defined area is configured to store a portion of a message, which had to be stored in at least one of the plurality of mailbox areas, in DRAM memory cells, in substitution for the at least one mailbox area.

5. The system of claim 3, wherein the protocol-defined area stores a command set.

6. The system of claim 3, wherein the protocol-defined area stores a command, address or flag data for a data communication protocol between the first and second processors.

7. The system of claim 2, further comprising:
a NAND type flash memory accessible by the second processor, the NAND type flash memory comprising a NAND type memory cell structure.

8. The system of claim 2, wherein the multiport semiconductor memory device further comprises at least one dedicated memory area accessible by one of the first processor or the second processor within the memory cell array.

9. The system of claim 1, wherein the first task comprises a modulation/demodulation function.

10. The system of claim 1, wherein the second task comprises a multimedia information processing function.

11. The system of claim 2, wherein the multiprocessor system is one of vehicle-use mobile phone, a portable phone, a portable multimedia player (PMP), a PlayStation Portable (PSP), or a personal digital assistant (PDA).

12. The system of claim 1, wherein the predetermined memory capacity is a unit of a memory bank.

13. A multiport semiconductor memory device operationally connected between a first processor performing a first task and a second processor performing a second task, the device comprising:
at least one shared memory area respectively accessible through different ports by the first processor and the second processor and assigned as a predetermined memory capacity to a portion of a memory cell array, the at least one shared memory area comprising a disable area disabled in response to a specific address and a protocol-defined area for defining a specification related to a data communication between the first processor and the second processor; and
an internal register accessible in response to the specific address of the shared memory area to provide a data interface between the first and second processors, the internal register being located outside the memory cell array.

14. The device of claim 13, wherein the first processor is a communication processor and the second processor is an application processor.

15. The device of claim 13, wherein the internal register comprises a semaphore area for storing a control authority for the shared memory area and a plurality of mailbox areas for storing a message to be applied to one of the first processor and the second processor corresponding to a data transmission direction.

16. The device of claim 14, wherein the protocol-defined area stores a portion of a message, which had to be stored in at least one of the mailbox areas, in DRAM memory cells, in substitution for the at least one mailbox area.

17. The device of claim 14, wherein the protocol-defined area stores a command, address or flag data for a data communication protocol between the first and second processors.

18. The device of claim 13, further comprising:
at least one dedicated memory area accessible by one of the first processor or the second processor within the memory cell array.

19. A method of driving a multiport semiconductor memory device in a multiprocessor system, the multiprocessor system including the multiport semiconductor memory device operationally connected between a first processor performing a first task and a second processor performing a second task, and a nonvolatile semiconductor memory device operationally connected to the second processor, the method comprising:
arranging a protocol-defined area and a disable area within a memory cell array, the protocol-defined area defining a specification related to a data communication between the first and second processors and being accessible in common by the first and second processors through different ports within the multiport semiconductor memory device, the disable area being disabled in response to a specific address;
preparing an internal register outside the memory cell array to be accessible in response to the specific address; and
regularly writing a message to a pre-defined area by one of the first and second processors occupying the protocol-defined area, and then performing the data communication.

20. A method of accessing a multiport semiconductor memory device in a multiprocessor system, the multiprocessor system including the multiport semiconductor memory device operationally connected between a first processor performing a first task and a second processor performing a second task, and a nonvolatile semiconductor memory device operationally connected to the second processor, the method comprising:
preparing at least one shared memory area accessible in common by the first and second processors through different ports within the multiport semiconductor memory device and assigned as a predetermined memory capacity to a portion of a memory cell array, the shared memory area including a disable area disabled in response to a specific address and a protocol-defined area for defining a specification related to a data communication between the first and second processors;
arranging an internal register outside the memory cell array accessible in response to a specific address of the shared memory area;
writing a message to a pre-defined area by one of the first and second processors accessing the protocol-defined area and writing data to a data storage area of the shared memory area, and then indicating a write event to a mailbox of the internal register; and
reading the mailbox by the other one of the first and second processors to retrieve the message written to the protocol-defined area, and then reading data written to the data storage area of the shared memory area.
